(19) United States
(12) Patent Application Publication
(10) Pub. No.: US 2012/0326396 A1
(43) Pub. Date: Dec. 27, 2012

(54) SEALING SYSTEM

(75) Inventors: Kenichi Ajiki, Kitaibaraki-shi (JP); Yoshiyuki Abe, Kitaibaraki-shi (JP)

(73) Assignee: NOK CORPORATION, Tokyo (JP)

(21) Appl. No.: 13/520,648

(22) PCT Filed: Apr. 18, 2011
(86) PCT No.: PCT/JP11/59526

§ 371 Date: Jul. 5, 2012

(51) Int. Cl. F16J 15/32

(52) U.S. Cl. 277/562

(57) ABSTRACT

There is provided a sealing system with improved durability.

In a sealing system in which a dust seal includes a first dust seal 100 and a second dust seal 200 provided on an atmosphere side of the first dust seal 100 and each of the first dust seal 100 and the second dust seal 200 has (a) seal lip(s) for sliding on an outer peripheral face of the shaft, the seal lips 121 and 122 of the first dust seal 100 are made of polyurethane rubber and the seal lip 221 of the second dust seal 200 is made of rubber having higher flexibility than the polyurethane rubber and is only the seal lip 221 extending toward the atmosphere side.

### TECHNICAL FIELD

The present invention relates to a sealing system including a dust seal.

### BACKGROUND ART

For example, in a hydraulic cylinder for a construction machine, a sealing system including a plurality of seals is used to seal an annular clearance between a cylinder (housing) and a piston (shaft). This sealing system includes a main seal for preventing leakage of a fluid such as oil to be sealed and a dust seal for preventing entry of dust into a sealed area. In general, only one dust seal made of polyurethane rubber is disposed on an atmosphere side.

However, in case of use under extremely harsh environments, two dust seals are used side by side. An example of the use under the extremely harsh environments is use at an iron ore mine where dust includes frozen substances, substances adhering to a surface of the piston, mud, and the like besides mine dust.

Such a prior-art sealing system will be described with reference to FIGS. 11 and 12. FIG. 11 is a schematic sectional view showing a state of use of the prior-art sealing system. FIG. 12 is a plan view schematically showing a second dust seal in the prior-art sealing system.

The prior-art sealing system shown in the drawings is used to seal an annular clearance between an inner peripheral face of a shaft hole formed in a housing 500 and an outer peripheral face of a shaft 300 inserted into the shaft hole. The prior-art sealing system includes a main seal 600 for preventing leakage of a sealed fluid to an atmosphere side (A) and a dust seal 700 for preventing entry of dust into a sealed fluid side (O). In this prior art, the dust seal 700 includes a first dust seal 710 provided on a side of the main seal 600 and a second dust seal 720 provided on the atmosphere side (A) of the first dust seal 710.

Here, the housing 500 includes a housing main body 510 and a fastened member 520 which can be fastened to and detached from the housing main body 510 by using bolts or the like.

An annular groove 511 is formed in the inner peripheral face of the shaft hole in the housing main body 510. Into the annular groove 511, the main seal 600 is mounted. In the prior art, the main seal 600 includes U-shaped packing 610 having a U-shaped section and a backup ring 620 for protecting an inner peripheral end edge of the U-shaped packing 610 on the atmosphere side (A).

At an opening end portion of the shaft hole in the housing main body 510 on the atmosphere side (A), an annular recessed portion 512 forming a step is formed. Into the annular recessed portion 512, the first dust seal 710 is mounted. The first dust seal 710 includes a metal ring 711 and a seal main body 712 integrally provided to the metal ring 711. The first dust seal 710 is fixed while positioned in an axial direction by fastening the fastened member 520.

At an opening end portion of the shaft hole in the fastened member 520 on the atmosphere side (A), an annular recessed portion 521 forming a step is formed. Into the annular recessed portion 521, the second dust seal 720 is mounted. Similarly to the first dust seal 710, the second dust seal 720 includes a metal ring 721 and a seal main body 722 integrally provided to the metal ring 721. The second dust seal 720 is fixed while positioned in the axial direction by fitting a snap ring 530 into an annular groove formed in the inner peripheral face of the shaft hole in the fastened member 520. In this manner, in the prior-art sealing system, the two dust seals are used side by side. Therefore, as compared with a case in which only one dust seal is provided, it is possible to more reliably prevent entry of the dust into the sealed fluid side (O).

Here, the first dust seal 710 does not have a cut portion in a circumferential direction similarly to a common dust seal. Therefore, in assembly, the first dust seal 710 needs to be fitted from an end portion of the shaft 300 or the shaft 300 needs to be inserted through the first dust seal 710.

On the other hand, the second dust seal 720 is exposed to the atmosphere and therefore deteriorates fast when used under an extremely harsh environment. For example, mud water or the like adheres to and cakes on the seal main body 722 or the mud water or the like which has adhered to the seal main body 722 is frozen. If the seal main body 722 and the shaft 300 slide on each other in this state, it promotes wearing of a seal lip of the seal main body 722.

Because the second dust seal 720 is likely to deteriorate as described above, it is formed so that it can be replaced easily. To put it more concretely, the second dust seal 720 has a structure which is split into two. In other words, as shown in FIG. 12, a member which is circular in a top view is cut into two and the two semicircular members form the second dust seal 720. In this way, the respective members obtained by splitting can be attached to and detached from an outer periphery side of the shaft 300. Therefore, by only detaching the fastened member 520 from the housing main body, detaching the deteriorating second dust seal 720, and fastening the fastened member 520 again after attaching a new seal 720, it is possible to easily replace the second dust seal 720.

However, to manufacture the second dust seal 720, the member which is circular in the top view is formed first and then split into two by cutting. Because the second dust seal 720 has the metal ring 721, a cutting edge of certain thickness needs to be used to cut the metal ring 721. In general, the member is cut with a grinder or the like.

Therefore, part of the metal ring 721 and part of the seal main body 722 are shaved off (shaved parts c1 and c2 are shown in FIG. 12). Therefore, the two members obtained by splitting do not form a perfect circle when they are connected to each other and it is unavoidable that a clearance is formed between cut end portions when the second dust seal 720 is attached to the housing 500. To put it concretely, clearances of about 2.5 mm are formed at the maximum. Therefore, entry of the dust from these clearances cannot be prevented.

To cope with this, there is a known technique employing, as a second dust seal, a member which is made of polyurethane rubber only and cut at only a position in a circumferential direction with a cutting edge thin enough to eliminate the need for a shaving margin (see Patent Literature 1).

With this technique, however, it is still difficult to completely prevent entry of especially minute dust, because there is still a cut portion. Once the dust enters from the second dust seal, it promotes wearing of a lip to thereby facilitate entry of the dust.

The dust which has entered from the second dust seal is prevented from entering a main seal side by the first dust seal. However, the dust accumulates in a sealed area between the first dust seal and the second dust seal. The dust accumulating in the sealed area is sealed with the first dust seal and the second dust seal and therefore cannot escape from the sealed area. Therefore, if an amount of accumulation exceeds a predetermined amount, loads (pressure of the accumulating dust) are applied on the first dust seal and the second dust seal. The loads may break the first dust seal and the second dust seal.

Accumulation of the dust is more likely to occur in a case of minute dust (which is 10 μm or smaller in particle diameter) such as mine dust than in a case of frozen substances or mud. Such minute dust enters not only from the cut portion but also from a tip end side of the lip, if the second dust seal is made of relatively hard material such as polyurethane rubber.

In this manner, the dust which has entered from the second dust seal and accumulated causes breakage of the first dust seal and the second dust seal and shortens the life of the dust seals.

As other related techniques, there are ones disclosed in Patent Literatures 2 to 5.

### CITATION LIST

### Patent Literature

Patent Literature 1: Japanese Patent Application Laid-Open No. 2008-223900
Patent Literature 2: Japanese Utility Model Application Publication No. 5-14050
Patent Literature 3: Japanese Patent Application Laid-Open No. 2001-355739
Patent Literature 4: Japanese Utility Model Application Laid-Open No. 59-22360
Patent Literature 5: Japanese Utility Model Application Laid-Open No. 5-83410

### SUMMARY OF INVENTION

### Technical Problem

It is an object of the present invention to provide a sealing system with improved durability.

### Solution to Problem

In the present invention, the following approach to solving the above-described problem is taken.

More specifically, a sealing system according to the invention is a sealing system for sealing an annular clearance between an inner peripheral face of a shaft hole formed in a housing and an outer peripheral face of a shaft which is inserted into the shaft hole and reciprocates relatively with respect to the housing, the system including

a main seal for preventing leakage of a sealed fluid to an atmosphere side and

a dust seal disposed on an atmosphere side of the main seal to prevent entry of dust into a sealed fluid side,

wherein the dust seal includes a first dust seal and a second dust seal provided on the atmosphere side of the first dust seal, each of the first dust seal and the second dust seal has a seal lip for sliding on the outer peripheral face of the shaft,

the seal lip of the first dust seal is made of polyurethane rubber,

the seal lip of the second dust seal is made of rubber having higher flexibility than the polyurethane rubber and is only the seal lip extending toward the atmosphere side.

Here, the seal lip made of the polyurethane rubber is excellent in a function of scraping off dust which has caked on the outer peripheral surface of the shaft. On the other hand, the seal lip made of rubber (e.g., NBR) having higher flexibility than the polyurethane rubber is excellent in a function of suppressing entry of minute dust.

In the invention, as described above, the second dust seal having the seal lip made of the rubber having higher flexibility than the polyurethane rubber is provided on the atmosphere side. Therefore, it is possible to suppress the entry of the minute dust with the second dust seal. Moreover, the dust which has entered from the second dust seal and caked on the outer peripheral surface of the shaft is scraped off by the first dust seal having the seal lip made of polyurethane rubber. Because the seal lip of the second dust seal is the only seal lip extending toward the atmosphere side, the dust scraped off by the first dust seal is discharged toward the atmosphere side from a tip end side of the seal lip of the second dust seal. Therefore, it is possible to prevent accumulation of the dust in a sealed area between the first dust seal and the second dust seal and application of loads on these dust seals.

Preferably, a tip end of the seal lip of the second dust seal is formed by an edge and is formed so that the edge protrudes toward the atmosphere side when it is in contact with the surface of the shaft.

In this way, the lip tip end of the seal lip appropriately comes in close contact with the rough surface (with microscopic asperities) of the shaft. Because no clearance is formed between the lip tip end and the surface of the shaft, it is possible to suppress the entry of the dust more.

### Advantageous Effects of Invention

As described above, with the invention, it is possible to improve durability.

### BRIEF DESCRIPTION OF DRAWINGS

FIG. 1 is a schematic sectional view of a sealing system according to an embodiment of the present invention.

FIG. 2 is a schematic sectional view of a first dust seal and a second dust seal according to an example 1 of the invention.

FIG. 3 is a schematic sectional view of a first dust seal and second dust seals according to an example 2 of the invention.

FIG. 4 is a schematic sectional view of first dust seals and a second dust seal according to an example 3 of the invention.

FIG. 5 is a schematic sectional view of a first dust seal and second dust seals according to an example 4 of the invention.

FIG. 6 is a schematic sectional view of first dust seals and second dust seals according to an example 5 of the invention.

FIG. 7 is a schematic sectional view of a first dust seal and a second dust seal according to an example 6 of the invention.

FIG. 8 is a drawing for explaining a mechanism of entry of dust when a lip tip end is formed by a curved face (round face).

FIG. 9 is a schematic sectional view of a second dust seal according to an example 7 of the invention.

FIG. 10 is a schematic sectional view of a first dust seal and the second dust seal according to the example 7 of the invention.

FIG. 11 is a schematic sectional view showing a state of use of a prior-art sealing system.

FIG. 12 is a plan view schematically showing a second dust seal in the prior-art sealing system.

### DESCRIPTION OF EMBODIMENTS

With reference to the drawings, modes for carrying out the present invention will be specifically described below by exemplification based on an embodiment and examples. However, dimensions, materials, shapes, relative positions of component parts described in the embodiment and the examples are not intended to limit the scope of the invention to themselves unless otherwise specified.

### Embodiment

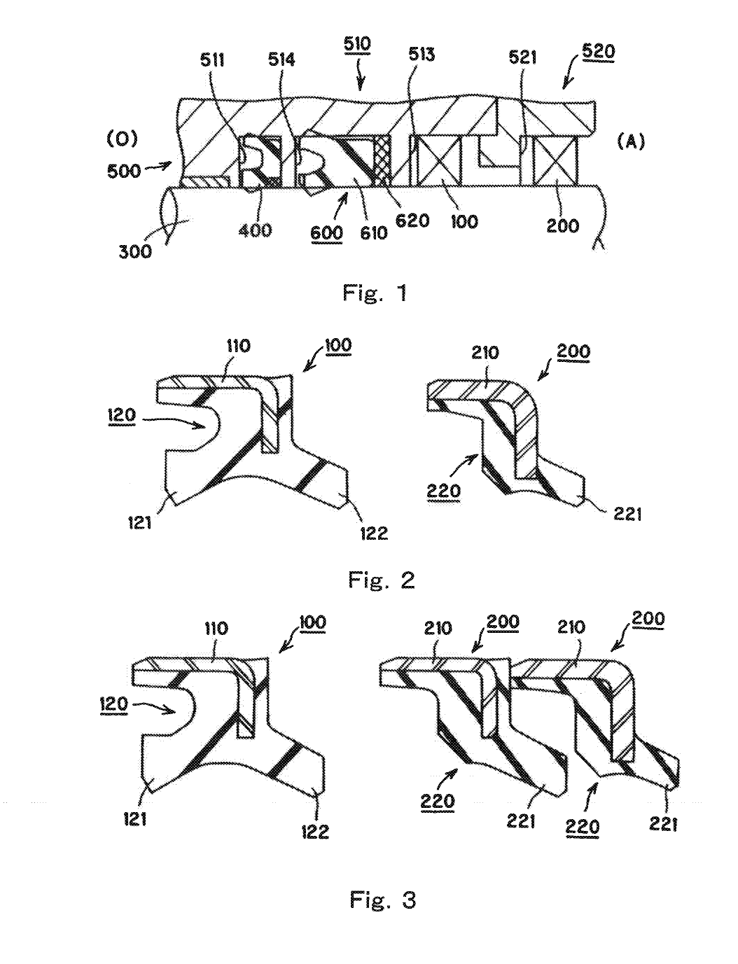

With reference to FIG. 1, a sealing system according to the embodiment of the present invention will be described. FIG. 1 is a schematic sectional view of a sealing system according to the embodiment of the invention.

### <Sealing System>

The sealing system according to the embodiment is used to seal an annular clearance between an inner peripheral face of a shaft hole formed in a housing 500 and an outer peripheral face of a shaft 300 inserted into the shaft hole. As a more concrete example, the sealing system is used for a hydraulic cylinder for a construction machine. In the case of the hydraulic cylinder, the cylinder corresponds to the housing 500, a piston corresponds to the shaft 300, and the shaft 300 reciprocates in the housing 500.

The sealing system according to the embodiment includes a buffer ring 400 for buffering pressure of a sealed fluid (e.g., oil), a main seal 600 for preventing leakage of the sealed fluid to an atmosphere side (A), and a first dust seal 100 and a second dust seal 200 for preventing entry of the dust into a sealed fluid side (O).

Here, the housing 500 includes a housing main body 510 and a fastened member 520 which can be fastened to and detached from the housing main body 510 by using bolts or the like.

A first annular groove 511 and a second annular groove 514 are formed in the inner peripheral face of the shaft hole in the housing main body 510. The buffer ring 400 is mounted into the first annular groove 511 and the main seal 600 is mounted into the second annular groove 514. In the embodiment, the main seal 600 includes U-shaped packing 610 having a U-shaped section and a backup ring 620 for protecting an end edge of the U-shaped packing 610 on the atmosphere side (A). The U-shaped packing 610 has a seal lip for sliding against the shaft 300.

At an opening end portion of the shaft hole in the housing main body 510 on the atmosphere side (A), an annular recessed portion 513 forming a step is formed. Into the annular recessed portion 513, the first dust seal 100 is mounted. At an opening end portion of the fastened member 520 on the atmosphere side (A), an annular recessed portion 521 forming a step is formed. Into the annular recessed portion 521, the second dust seal 200 is mounted.

### <Dust Seal>

The first dust seal 100 is provided on the main seal 600 side and the second dust seal 200 is provided on the atmosphere side of the first dust seal 100. Each of the first dust seal 100 and the second dust seal 200 does not have a cut portion at any circumferential position.

The sealing system according to the embodiment is intended to be used under environments including extremely harsh environments such as an iron ore mine. Therefore, the dust to be prevented by the dust seals from entering includes substances, which easily cake on a surface of the shaft 300, and substances, which are large and hard to some extents, such as frozen substances, mud, and particles of iron ore besides minute dust such as mine dust.

The first dust seal 100 include a seal lip formed to be able to slide on the outer peripheral face of the shaft 300. The seal lip of the first dust seal 100 is made of polyurethane rubber.

The second dust seal 200 includes a seal lip formed to be able to slide on the outer peripheral face of the shaft 300. The seal lip of the second dust seal 200 is made of rubber (e.g., NBR) having higher flexibility than the polyurethane rubber and includes only a seal lip extending toward the atmosphere side.

Here, the seal lip made of the polyurethane rubber is excellent in a function of scraping off the dust which has caked on the outer peripheral surface of the shaft 300. On the other hand, the seal lip made of the rubber having the higher flexibility than the polyurethane rubber is excellent in a function of suppressing entry of the minute dust.

<Advantages of the Seal System According to the Embodiment>

In the seal system according to the embodiment, the second dust seal 200 having the seal lip made of the rubber having the higher flexibility than the polyurethane rubber is provided on the atmosphere side. Therefore, the second dust seal 200 can suppress entry of the minute dust.

Moreover, the dust which has entered from the second dust seal 200 and caked on the outer peripheral surface of the shaft is scraped off by the first dust seal 100 having the seal lip made of polyurethane rubber. Because the seal lip of the second dust seal 200 includes only the seal lip extending toward the atmosphere side (A), the dust scraped off by the first dust seal 100 is discharged toward the atmosphere side (A) from the seal lip side of the second dust seal 200. In this way, it is possible to suppress loads applied on the first dust seal 100 and the second dust seal 200 due to accumulation of the dust in a sealed area between these dust seals.

### Comparative Examples

Comparative examples in which the structures and the materials of the seal lips are changed will be described below.

### Comparative Example 1

In a comparative example 1, a first dust seal which is the same as that in the embodiment is employed. As a second dust seal, a seal in which the same rubber material as in the embodiment is used for a seal lip and which has a seal lip extending toward the sealed fluid side (O) as well as the seal lip extending toward the atmosphere side (A) is employed.

The comparative example 1 employs the seal lip made of rubber having the higher flexibility than the polyurethane rubber as the second dust seal and therefore can satisfactorily prevent entry of the minute dust.

However, it is impossible to completely prevent entry the minute dust and therefore the minute dust accumulates in a sealed area between the first dust seal and the second dust seal with time. Then, the accumulating dust is sealed with the first dust seal and the second dust seal and therefore cannot escape from the sealed area. As a result, loads are applied on the first dust seal and the second dust seal and may break the first dust seal and the second dust seal.

### Comparative Example 2

In a comparative example 2, a second dust seal which is the same as that in the embodiment is employed. As a first dust seal, a seal having a seal lip made of rubber having higher flexibility than the polyurethane rubber is employed.

In the comparative example 2, both the first dust seal and the second dust seal include the seal lips made of rubber having the higher flexibility than the polyurethane rubber and therefore it is possible to satisfactorily prevent entry of the minute dust. However, with these seal lips, it is impossible to scrape off the dust which has caked on the outer peripheral surface of the shaft 300 and the dust enters the main seal 600 side. Therefore, sealing performance of the main seal 600 is impaired early.

### Comparative Example 3

In a comparative example 3, a first dust seal which is the same as that in the embodiment is employed. As a second dust seal, a seal having a seal lip made of the polyurethane rubber is employed.

In the comparative example 3, both the first dust seal and the second dust seal include the seal lips made of the polyurethane rubber and therefore it is possible to satisfactorily scrape off the dust which has caked on the outer peripheral surface of the shaft 300. However, with these seal lips, it is impossible to prevent entry of the minute dust. Therefore the minute dust exists between tip ends of the seal lips of the respective seals and the outer peripheral surface of the shaft 300 and the respective seal lips wear early.

### Comparative Example 4

In a comparative example 4, as a first dust seal, a seal having a seal lip made of rubber having higher flexibility than the polyurethane rubber is employed. As a second dust seal, a seal having a seal lip made of the polyurethane rubber is employed.

In the comparative example 4, because the seal lip of the second dust seal provided on the atmosphere side is made of polyurethane rubber, the second dust seal cannot satisfactorily suppress entry of the minute dust. Therefore, the minute dust enters a sealed area between the first dust seal and the second dust seal. Although the seal lip of the second dust seal includes only the seal lip extending toward the atmosphere side (A), the polyurethane rubber has high rigidity and therefore the seal lip of the second dust seal cannot effectively discharge the dust toward the atmosphere side (A) like the seal lip made of the rubber such as NBR. Rather, the seal lip of the first dust seal extending toward the atmosphere side and made of the rubber such as the NBR is deformed toward the sealed fluid side (O) and gets broken.

Next, some more concrete examples of the first dust seal 100 and the second dust seal 200 will be described.

### Example 1

With reference to FIG. 2, a first dust seal and a second dust seal according to an example 1 of the invention will be described. FIG. 2 is a schematic sectional view of the first dust seal and the second dust seal according to the example 1 of the invention.

The first dust seal 100 according to the example includes a metal ring 110 having an L-shaped section and a seal main body 120 integrally provided to the metal ring 110. The seal main body 120 is made of polyurethane rubber and includes a first seal lip 121 extending toward the sealed fluid side (O) and a second seal lip 122 extending toward the atmosphere side (A). Both the first seal lip 121 and the second seal lip 122 slide on a shaft 300.

The first seal lip 121 performs a function of suppressing leakage of the sealed fluid, which has leaked from the main seal 600, toward the atmosphere side (A). The second seal lip 122 performs a function of scraping off dust which has caked on an outer peripheral surface of the shaft 300.

The second dust seal 200 according to the example includes a metal ring 210 having an L-shaped section and a seal main body 220 integrally provided to the metal ring 210. The seal main body 220 is made of rubber (e.g., NBR) having higher flexibility than the polyurethane rubber and includes a seal lip 221 extending toward the atmosphere side (A). The second dust seal 200 performs a function of suppressing entry of the minute dust. Because seal lip 221 of the second dust seal 200 extends toward the atmosphere side (A), it is bent toward the atmosphere side (A) by a relatively weak force. Therefore, the dust accumulating in the sealed area between the first dust seal 100 and the second dust seal 200 is discharged from a tip end side of the seal lip 221 toward the atmosphere side (A). In this way, it is possible to suppress application of loads of the dust, accumulating in the sealed area, on the first dust seal 100 and the second dust seal 200.

### Example 2

With reference to FIG. 3, a first dust seal and second dust seals according to an example 2 of the invention will be described. FIG. 3 is a schematic sectional view of the first dust seal and the second dust seals according to the example 2 of the invention.

The first dust seal 100 according to the example has the same structure as the first dust seal in the above-described example 1. In the present example, the two second dust seals 200 are provided side by side. A structure of each of the second dust seals 200 is the same as that of the second dust seal 200 in the example 1.

With the dust seals according to the present example, it is possible to suppress the entry of the minute dust more than in the example 1.

### Example 3

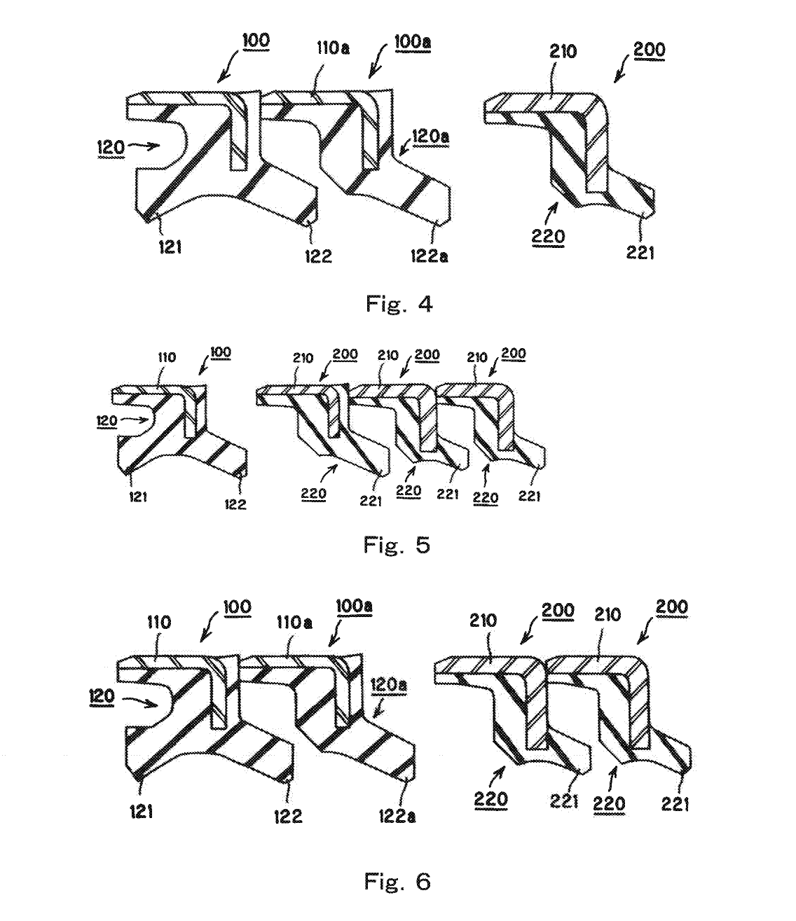

With reference to FIG. 4, first dust seals and a second dust seal according to an example 3 of the invention will be described. FIG. 4 is a schematic sectional view of the first dust seals and the second dust seal according to the example 3 of the invention.

The second dust seal 200 according to the present example has the same structure as the second dust seal in the above-described example 1. In the present example, the first dust seal 100 having the same structure as that in the above-described example 1 and the first dust seal 100a having a different structure from the first dust seal 100 and disposed on an atmosphere side (A) of the first dust seal 100 are provided side by side.

The first dust seal 100a includes a metal ring 110a having an L-shaped section and a seal main body 120a integrally provided to the metal ring 110a. The seal main body 120a is made of polyurethane rubber and includes a seal lip 122a extending toward the atmosphere side (A). The first dust seal 100a is different from the first dust seal 100 in that it is not provided with a seal lip extending toward a sealed fluid side (O).

The seal lip 122a of the first dust seal 100a also performs a function of scraping off dust which has caked on an outer peripheral surface of a shaft 300.

With the dust seals according to the present example, it is possible to scrape off the dust which has caked on the outer peripheral surface of the shaft 300 more than in the example 1. Because the first dust seal 100a is not provided with the seal lip extending toward the sealed fluid side (O), the dust which has been scraped off by the first dust seal 100 is discharged from the tip end side of the seal lip 122a of the first dust seal 100a toward the atmosphere side.

### Example 4

With reference to FIG. 5, a first dust seal and second dust seals according to an example 4 of the invention will be described. FIG. 5 is a schematic sectional view of the first dust seal and the second dust seals according to the example 4 of the invention.

The first dust seal 100 according to the present example has the same structure as the first dust seal in the above-described example 1. In the present example, the three second dust seals 200 are provided side by side. A structure of each of the second dust seals 200 is the same as that of the second dust seal 200 in the example 1.

With the dust seals according to the present example, it is possible to suppress entry of minute dust more than in the example 2.

### Example 5

With reference to FIG. 6, first dust seals and second dust seals according to an example 5 of the invention will be described. FIG. 6 is a schematic sectional view of the first dust seals and the second dust seals according to the example 5 of the invention.

In the present example, the first dust seals have the same structures as those in the above-described example 3. In other words, the first dust seal 100 including the first seal lip 121 and the second seal lip 122 and the first dust seal 100a including only the seal lip 122a extending toward the atmosphere side (A) are disposed side by side.

The second dust seals have the same structures as those in the above-described example 2. In other words, the two second dust seals having the same structures as the second dust seal 200 in the example 1 are provided side by side.

With the dust seals according to the present example, it is possible to suppress entry of minute dust more and it is possible to scrape the dust which has caked on an outer peripheral surface of a shaft 300 more than in the example 1.

### Example 6

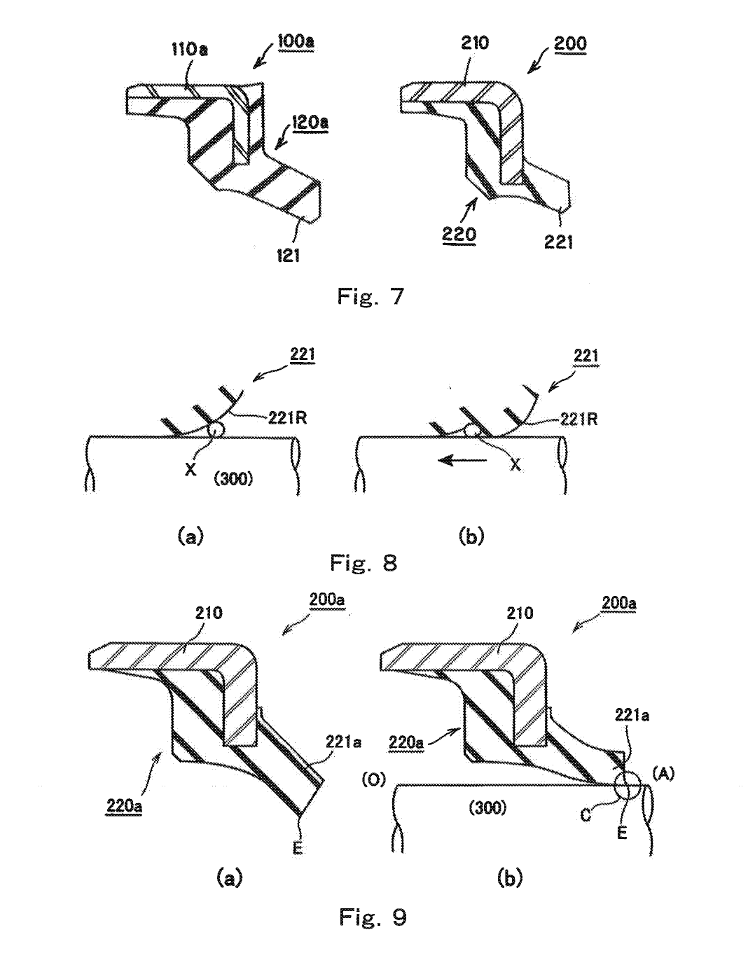

With reference to FIG. 7, a first dust seal and a second dust seal according to an example 6 of the invention will be described. FIG. 7 is a schematic sectional view of the first dust seal and the second dust seal according to the example 6 of the invention.

The second dust seal 200 according to the present example has the same structure as the second dust seal in the above-described example 1. As the first dust seal 100a according to the present example, the first dust seal 100a shown in the above-described examples 3 and 5 and including only the seal lip 122a extending toward the atmosphere side (A) is employed.

With the dust seals according to the present example, it is possible to obtain similar effects to those in the above-described example 1 except that the dust seal do not have the function of suppressing leakage of the sealed fluid, leaking from the main seal 600, toward the atmosphere side (A).

### Example 7

With reference to FIGS. 8(a) to 10, a second dust seal according to an example 7 of the invention will be described. As described above, if the seal lip 221 of the second dust seal is made of the rubber having the higher flexibility than the polyurethane rubber, it can perform the function of suppressing the entry of the minute dust. However, if a lip tip end 221R of the seal lip 221 is formed by a curved face (round face), the function of suppressing the entry of the minute dust may not be performed satisfactorily. This point will be described with reference to FIGS. 8(a) and 8(b). If the lip tip end 221R of the seal lip 221 is formed by the curved face, there is a clearance between the surface of the shaft 300 and the lip tip end 221R as shown in FIG. 8(a). Therefore, if the shaft 300 relatively moves toward the sealed fluid side (O) with the minute dust X in the clearance (see an arrow in FIG. 8(b)), the dust X may enter the sealed fluid side (O) in some cases. Therefore, in the present example, a structure for suppress the entry of the dust X more will be shown.

FIGS. 9(a) and 9(b) are schematic sectional views of the second dust seal 200a according to the example. FIG. 9(a) is the schematic sectional view of only the second dust seal 200a and FIG. 9(b) is the schematic sectional view of a state in which a seal lip is in contact with (sliding against) the shaft 300.

Similarly to the second dust seal 200 in each of the above-described examples, the second dust seal 200a according to the present example includes a metal ring 210 having an L-shaped section and a seal main body 220a integrally provided to the metal ring 210. The seal main body 220a is made of rubber (e.g., NBR) having higher flexibility than the polyurethane rubber and includes a seal lip 221a extending toward the atmosphere side (A).

In the example, a lip tip end of the seal lip 221a is formed by an edge E. In other words, the lip tip end of the seal lip 221a has not a curved face (round face) but an acute angle (see FIG. 9(a)). When the seal lip 221a is in contact with (sliding on) a surface of a shaft 300, the edge E protrudes toward the atmosphere side (A) as shown in a circle C in FIG. 9(b).

In the example, by employing the above-described structure, the lip tip end of the seal lip 221a appropriately comes in close contact with the rough surface (with microscopic asperities) of the shaft 300. Because no clearance is formed between the lip tip end and the surface of the shaft 300, it is possible to suppress occurrence of the above-described phenomenon shown in FIGS. 8(a) and 8(b) to suppress entry of the dust X more. If the lip tip end is formed by the edge E, it is possible to reduce an amount of entry of the dust X by about one third as compared with the lip tip end formed by the curved face (round face).

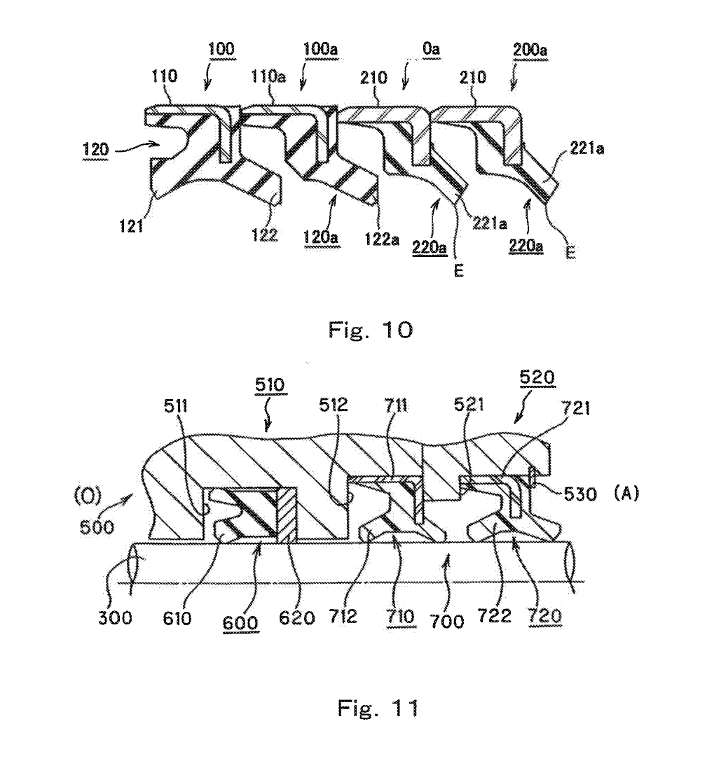

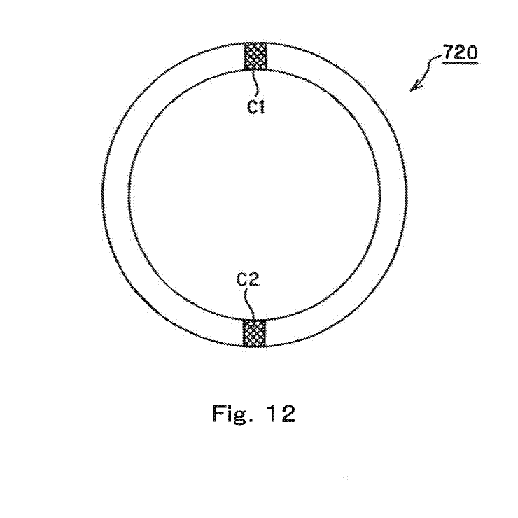

The second dust seal 200a according to the present example can be applied to any of the above-described examples 1 to 6. As an example, FIG. 10 shows a case in which the second dust seal 200a according to the present example is applied to the example 5.

(Others)

In the above-described embodiment, the structure in which the first dust seal 100 is mounted into the annular recessed portion 513 formed in the housing main body 510 and the second dust seals 200 is mounted into the annular recessed portion 521 formed in the fastened member 520 is shown.

However, if a plurality of first dust seals 100 and a plurality of second dust seals 200 are used, not all the first dust seals 100 need to be mounted into the annular recessed portion 513 and not all the second dust seals 200 need to be mounted into the annular recessed portion 521. In other words, if the first dust seal 100 which is disposed the closest to the sealed fluid side (O) is mounted into the annular recessed portion 513 and the second dust seal 200 which is disposed the closest to the atmosphere side (A) is mounted into the annular recessed portion 521, the other dust seals may be disposed into any of the recessed portions.

### REFERENCE SIGNS LIST

100, 110a first dust seal
110, 110a metal ring
120, 120a seal main body
121 first seal lip
122 second seal lip
122a seal lip
200, 200a second dust seal
210 metal ring
220, 220a seal main body
221, 221a seal lip
300 shaft
400 buffer ring
500 housing
510 housing main body
511 first annular groove
513 annular recessed portion
514 second annular groove
520 fastened member
521 annular recessed portion
600 main seal
E edge

1. A sealing system for sealing an annular clearance between an inner peripheral face of a shaft hole formed in a housing and an outer peripheral face of a shaft which is inserted into the shaft hole and reciprocates relatively with respect to the housing, the system comprising:
a main seal for preventing leakage of a sealed fluid to an atmosphere side; and
a dust seal disposed on an atmosphere side of the main seal to prevent entry of dust into a sealed fluid side,
wherein the dust seal includes a first dust seal and a second dust seal provided on the atmosphere side of the first dust seal, each of the first dust seal and the second dust seal has a seal lip for sliding on the outer peripheral face of the shaft,
the seal lip of the first dust seal is made of polyurethane rubber,
the seal lip of the second dust seal is made of rubber having higher flexibility than the polyurethane rubber and is only a seal lip extending toward the atmosphere side.

2. The sealing system according to claim 1, wherein a tip end of the seal lip of the second dust seal is formed by an edge and is formed so that the edge protrudes toward the atmosphere side when it is in contact with the surface of the shaft.
